(19) United States
(12) Patent Application Publication
(10) Pub. No.: US 2023/0050875 A1
(43) Pub. Date: Feb. 16, 2023

(54) Retractable Wind-Powered Generator Device for Vehicles

(71) Applicant: Robert W. Riley, Mooresville, NC (US)

(72) Inventor: Robert W. Riley, Mooresville, NC (US)

(21) Appl. No.: 17/975,780

(22) Filed: Oct. 28, 2022

Related U.S. Application Data
(63) Continuation-in-part of application No. 17/728,312, filed on Apr. 25, 2022, now abandoned.
(60) Provisional application No. 63/184,280, filed on May 5, 2021.

(51) Int. Cl. B60L 8/00; B60L 53/20; F03D 9/32

(52) U.S. Cl. CPC B60L 8/006; B60L 53/20; F03D 9/32; F05B 2240/941

(57) ABSTRACT

Wind-powered generator devices, systems, and methods are described that include a wind turbine, an electrical converter to convert variable frequency power output from the wind turbine to fixed frequency electricity for storage in a vehicle or other battery or to power an electrical device, a support member to which the wind turbine is attached, a mounting device to which a bottom end of the support member is attached, wherein the mounting device attaches the wind-powered generator device to a vehicle or another object or a surface, and an elevating device that includes a first connection to which a bottom end of the support member is attached and a second connection to which the mounting device is attached. The wind turbine and support member are configurable in a vertical operating position that is raised and in a horizontal retracted position that is lowered when the wind turbine not in operation.

### CROSS-REFERENCE TO RELATED APPLICATIONS

This application is a nonprovisional application of and claims priority from U.S. Provisional Pat Application Serial No. 63/184,280 filed on May 5, 2021, and is a continuation-in-part application of U.S. Nonprovisional Pat Application Serial No. 17/728,312 filed on Apr. 25, 2022. The foregoing applications are incorporated in their entirety herein by reference.

### FIELD OF THE INVENTION

The invention relates to automobile and vehicle accessories. More particularly, the invention relates to a vehicle-mounted, wind-powered generator for powering a vehicle.

### BACKGROUND

Drivers and owners of an electric vehicle (EV) and of hybrid vehicle owners (meaning vehicles that are powered both by fossil fuels as well as electricity) must rely on public charging stations, especially in urban areas. If the owner cannot charge the EV at a convenient location, e.g., at home or at work, use of the EV may be hindered. A driver or an automobile owner may not have a parking spot or may not have parking with access to a charging station or charging equipment. Lack of parking and lack of charging stations and equipment is often the case for apartment dwellers, who may find use or ownership of an EV to be difficult or inconvenient. Backup power is also a requirement when power outages occur or when a charging station or equipment is unavailable, for example, in remote rural areas.

A need exists for a source of electrical power to charge an EV, a hybrid vehicle, an electrical device, or a battery, which can be deployed quickly and efficiently. A need also exists for a source of electrical power that is attachable to an EV, a hybrid vehicle, an electrical device, or a battery, which can be retracted, collapsed, or detached and removed for storage, particularly in the case of vehicles when the vehicle is in motion. A further need exists for a source of electrical power to charge an EV, a hybrid vehicle, an electrical device, or a battery, which is derived from a renewable energy source.

### SUMMARY

The invention relates to wind-powered generator devices, systems, and methods that are useful for powering or charging an electric vehicle, a hybrid vehicle, an electrical device, or a battery. The wind-powered generator device includes a wind turbine, an electrical converter, a support member, and a mounting device. The wind turbine converts kinetic energy from wind to mechanical energy using its fan blade assembly, rotor hub, and gear box and converts this mechanical energy to electrical energy (i.e., electricity) using its generator. The electrical converter steps up voltage of electricity received from the generator of the wind turbine and converts variable frequency power output from the wind turbine to fixed frequency electricity for storage in a vehicle or other battery or to power an electrical device. The wind turbine is attached to a top end of the support member, which is raisable when the wind turbine is in use and is retractable or lowerable when the wind turbine is not in use. A bottom end of the support member is connected to the mounting device. The mounting device attaches the wind-powered generator device to a vehicle or another object or a surface.

In exemplary embodiments, the wind-powered generator devices, systems, and methods described herein include and utilize an elevating device to raise or elevate and to lower or retract the wind turbine and support member depending on whether a user intends to place the wind turbine in operation or to retract it for storage when not in operation. The elevating device may be manually operable or it may be motor-driven and automated. The elevating device includes a first connection to which the bottom end of the support member is attached and a second connection to which the mounting device is attached. The wind turbine and support member are configurable in a vertical operating position that is raised and in a horizontal retracted position that is lowered when the wind turbine not in operation.

The wind-powered generator devices, systems, and methods described herein provide an advantage in that they allow for powering or charging of an electric vehicle, an electrical device, or a battery using electric energy produced from the conversion of wind energy. The devices, systems, and methods described herein also provide an advantage by allowing for charging the battery of an electric or hybrid vehicle when the vehicle is not in operation. The devices, systems, and methods described herein also provide an advantage by providing a power supply from wind, which can be retracted or removed for storage when the devices and systems are not in operation.

Accordingly, the invention features a wind-powered generator device, wherein the wind-powered generator device includes a wind turbine that is retractable when not in operation, an electrical converter to convert variable frequency power output from the wind turbine to fixed frequency electricity for storage in a battery or to power a device, a support member to which the wind turbine is attached, a mounting device to which a bottom end of the support member is attached, wherein the mounting device attaches the wind-powered generator device to an object or a surface, and an elevating device that includes a first connection to which a bottom end of the support member is attached and a second connection to which the mounting device is attached. The wind turbine and support member are configurable in a vertical operating position that is raised and in a horizontal retracted position that is lowered when the wind turbine not in operation.

In another aspect, the invention can feature the battery being or including a battery of a vehicle, a home battery, or a battery of another electrical device.

In another aspect, the invention can feature the device being or including an electric vehicle, a hybrid vehicle, or another electrical device.

In another aspect, the invention can feature the object being or including an electric vehicle, a hybrid vehicle, another vehicle, a trailer, a building or other structure, or an electrical device.

In another aspect, the invention can feature the surface being or including a ground surface or a floor surface.

In another aspect, the invention can feature the mounting device being attachable to an exterior surface of a vehicle and being detachable for placement or mounting on another vehicle, structure, or ground surface.

In another aspect, the invention can feature the mounting device including rails that are attachable to a roof or other top surface of the vehicle, structure, or ground surface.

In another aspect, the invention can feature a yaw mechanism that is rotatable for orienting the wind turbine in a direction of wind.

In another aspect, the invention can feature the yaw mechanism being attached at a first end to the wind turbine and at a second end to a top end of the support member.

In another aspect, the invention can feature the wind turbine including a rudder to orient a fan side of the wind turbine in a direction from which wind is blowing.

In another aspect, the invention can feature the wind turbine including a nacelle enclosing a gear box and a generator of the wind turbine.

In another aspect, the invention can feature at least one power cable for connecting the electrical converter to the battery or to the device to transmit electricity generated by the wind turbine to the battery for storage or to the device to power the device.

In another aspect, the invention can feature a storage cover for enclosing the wind turbine, the electrical converter, the support member, and at least a part of the mounting device.

The invention also features a wind-powered vehicle system, wherein the wind-powered vehicle system includes a vehicle and a wind-powered generator device. The vehicle is an electric vehicle or a hybrid vehicle and includes a battery for storing electricity. The wind-powered generator device includes a wind turbine that is retractable when not in operation, an electrical converter to convert variable frequency power output from the wind turbine to fixed frequency electricity for storage in the battery of the vehicle, a support member to which the wind turbine is attached, a mounting device to which a bottom end of the support member is attached, and an elevating device that includes a first connection to which a bottom end of the support member is attached and a second connection to which the mounting device is attached. The wind turbine and support member are configurable in a vertical operating position that is raised and in a horizontal retracted position that is lowered when the wind turbine not in operation.

In another aspect, the invention can feature the mounting device being attachable to an exterior surface of the vehicle and being detachable for placement or mounting on another vehicle, structure, or ground surface.

In another aspect, the invention can feature the mounting device including rails that are attachable to a roof or other top surface of the vehicle.

In another aspect, the invention can feature a yaw mechanism that is rotatable for orienting the wind turbine in a direction of wind.

In another aspect, the invention can feature the yaw mechanism being attached at a first end to the wind turbine and at a second end to a top end of the support member.

In another aspect, the invention can feature the wind turbine including a rudder to orient a fan side of the wind turbine in a direction from which wind is blowing.

In another aspect, the invention can feature the wind turbine including a nacelle enclosing a gear box and a generator of the wind turbine.

In another aspect, the invention can feature at least one power cable for connecting the electrical converter to the battery of the vehicle to transmit electricity generated by the wind turbine to the battery for storage.

In another aspect, the invention can feature a storage cover for enclosing the wind turbine, the electrical converter, the support member, and at least a part of the mounting device.

A method of the invention can be used for powering a vehicle using wind. The method includes the step of: (a) mounting to a vehicle a wind-powered generator device. The wind-powered generator device includes a wind turbine that is retractable when not in operation and an electrical converter to convert variable frequency power output from the wind turbine to fixed frequency electricity for storage in a battery of a vehicle. The vehicle is an electric vehicle or a hybrid vehicle. The wind-powered generator device further includes a support member to which the wind turbine is attached, a mounting device to which a bottom end of the support member is attached, and an elevating device having a first connection to which a bottom end of the support member is attached and a second connection to which the mounting device is attached. The method further includes the steps of: (b) placing the wind turbine and support member in a vertical operating position that is raised to produce electricity as wind turns a fan blade assembly of the wind turbine; and (c) transmitting the electricity via at least one power cable to the battery of the vehicle for storage.

Another method of the invention can include the step of: (d) placing the wind turbine and support member in a horizontal retracted position that is lowered when the wind turbine is not in operation.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a top plan view of a wind-powered generator device installed on an automobile, wherein a wind turbine of the device is shown in a lowered or retracted or inoperable configuration.

FIG. 2 is a left side elevational view of the wind-powered generator of FIG. 1, wherein the wind turbine of the device is shown in a raised or elevated or operable configuration.

FIG. 3 is a left side elevational view of the wind-powered generator of FIG. 1, wherein the wind turbine of the device is shown in a lowered or retracted or inoperable configuration.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term "including" should be read to mean "including, without limitation," "including but not limited to," or the like; the term "having" should be interpreted as "having at least"; the term "includes" should be interpreted as "includes but is not limited to"; the term "example" is used to provide exemplary instances of the item in discussion, not an exhaustive or limiting list thereof; and use of terms like "preferably," "preferred," "desired," "desirable," or "exemplary" and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases "at least one" and "one or more" to introduce claim recitations; however, the use of such phrases should not be construed to imply that the introduction of a claim recitation by the indefinite articles "a" or "an" limits any particular claim containing such introduced claim recitation to embodiments containing only one such recitation, even when the same claim includes the introductory phrases "one or more" or "at least one" and indefinite articles such as "a" or "an" (e.g., "a" and "an" should typically be interpreted to mean "at least one" or "one or more"); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

The invention provides a wind-powered generator device 10 for converting kinetic energy of wind into electrical energy to supply power (i.e., electricity) to an electric automobile 100 or other vehicle 100. Examples of electric vehicles (or EVs) include automobiles (such as a cars, trucks, vans, recreational vehicles, and buses), tractors, lawnmowers, heavy equipment vehicles (e.g., bulldozers, front-end loaders, backhoes, excavators, dump trucks, forklifts, and cranes), military vehicles (e.g., tanks) motorcycles, motorized scooters, all-terrain vehicles, golf carts, trains, ships, boats, underwater vehicles, hovercraft, aircraft, and any other vehicle that is powered entirely or in part by electricity. For purposes of convenience, as used herein, the terms “electric vehicle” and “EV” include both fully electric vehicles and hybrid vehicles that are powered by a combination of both combustion engines burning fossil fuels or other power sources as well as electricity supplied either directly by the wind-powered generator device or indirectly by one or more batteries receiving electricity from the wind-powered generator device.

The wind-powered generator device may also be used to a supply power to an electrical device that is not a vehicle. For example, the wind-powered generator device is useful for supplying power to one or more electrical devices. An electrical device is a device that relies on electricity (i.e., electrical energy) to power one or more of its components or parts. The wind-powered generator device is intended for use with all types of vehicles that require electrical power for charging its main built-in battery (or batter packs). The wind-powered generator device is intended for use as a supplemental source of power to charge additional batteries or to run auxiliary electrical devices. Examples of such electrical devices include computers, cell phones, servers, printers, other electronics, lights, air conditioners, refrigerators, freezers, other appliances, lawn equipment, campers, chargers, and any other type of electrical device. The electrical device to which the wind-powered generator device is electrically connected can be inside, in contact with, or in a different location (generally near or adjacent to the wind-powered generator device but in a remote location in other instances). In embodiments in which the wind-powered generator device is installed on a vehicle, the electrical device may be inside, in contact with, or in a different location than the vehicle.

The wind-powered generator device may also be used to charge or otherwise transmit power to a battery for storage. Examples of such batteries include batteries of electric vehicles, hybrid vehicles, other vehicles, home batteries (including backup battery systems), batteries for one or more electrical devices, and any other battery that is chargeable, whether installed in a vehicle or electrical device or not installed in either of the foregoing.

The wind-powered generator device serves as a source of back-up electricity in case of power outages on a utility electrical power grid or system. The wind-powered generator device also serves to offset usage of electricity from the electrical power grid, thereby resulting in reduced electricity bills.

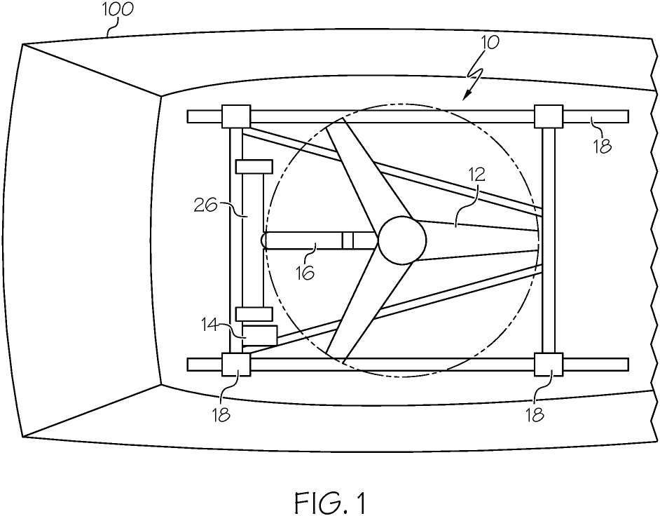

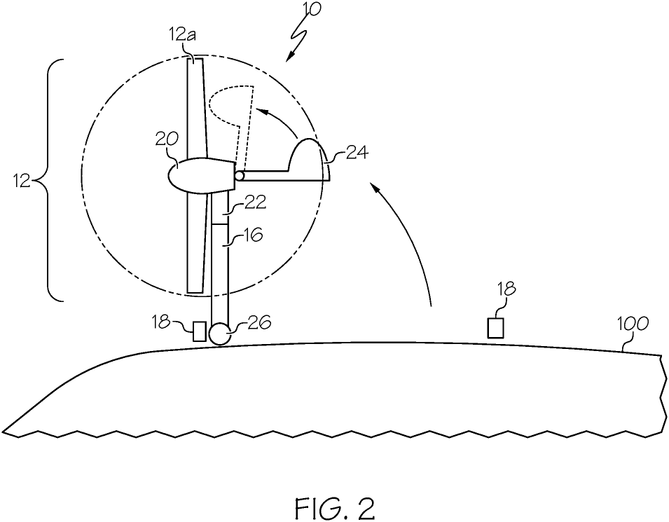

As shown in FIGS. 1-3, the wind-powered generator device 10 includes a wind turbine 12, an electrical converter 14, a support member 16, and a mounting device 18. The wind turbine (and in exemplary embodiments, the support member also) is retractable when the wind turbine is not in operation, e.g., when the wind-powered generator device is installed on top of a vehicle and the vehicle is being driven. The ability lower or retract the wind turbine, support member, or both reduces drag when the vehicle is in motion during driving but allows for fast and efficient operation of the wind turbine when the vehicle is parked. In exemplary embodiments, the wind turbine 12 includes one or more rotor blades 12a or fan blades connected to a rotor hub, a generator, and a gear box. A first shaft connects the rotor hub to the gear box, and a second shaft connects the gear box to the generator. The first shaft can be a low-speed shaft while the second shaft can be a high-speed shaft. The one or more rotor blades or fan blades and rotor hub are also referred to herein as a fan blade assembly or a fan. Wind impacting the fan blade assembly causes the fan blade assembly to rotate, which together with the other parts of the wind turbine, produces electricity. In other embodiments, the wind turbine may include other parts or configurations or arrangements of parts. In use as a component of the wind-powered generator device, any type of wind turbine may be used including horizontal-axis wind turbines and vertical-axis wind turbines. The wind-powered generator device may include more than one wind turbine. In embodiments that include more than one wind turbine, each wind turbine may be of the same type or of different types. In exemplary embodiments, the wind-powered generator device includes at least one horizontal-axis wind turbine.

In most embodiments, the wind turbine 12 further includes a nacelle 20 enclosing a gear box and a generator of the wind turbine. The nacelle is a housing or casing to enclose and protect the components of the wind turbine other than the fan blade assembly. The nacelle can be aerodynamic in shape. The nacelle may be constructed so as to be lightweight, waterproof, corrosion resistant, or a combination of two or more of the foregoing. For example, the nacelle may be constructed from plastic, aluminum, or stainless steel.

In exemplary embodiments, the wind-powered generator device 10 also includes a yaw mechanism 22 that is rotatable for orienting the wind turbine in a direction from which wind is blowing. The yaw mechanism may be an integral part of the wind turbine, an integral part of the support member, or a separate part of the wind-powered generator device. In some such embodiments, the yaw mechanism is disposed between the wind turbine and the support member, for example, between a bottom surface of the nacelle of the wind turbine and the top end of the support member. In other such embodiments, the yaw mechanism may be installed between a first portion and a second portion of the support member. In the most exemplary embodiments, the yaw mechanism is attached at a first end to the wind turbine and at a second end to the top end of the support member.

In some embodiments, the yaw mechanism 22 may be a rotating housing that surrounds all or part of the support member 16.

In exemplary embodiments, the wind turbine 12 includes a rudder 24 to orient a fan side of the wind turbine in a direction from which wind is blowing. The fan side of the wind turbine is a side of the wind turbine at which the fan blade assembly is located. The rudder rotates the fan depending on wind direction. The rudder may be extendable when the wind turbine is in operation and retractable for compact storage when the wind turbine is not in operation. For example, the rudder is extended when the wind turbine is erected in its vertical operating orientation. When the wind turbine is not in use, the rudder is retracted for storage, e.g., by folding. In some embodiments, the rudder may be removable for storage when the wind turbine is not in operation.

In some embodiments, the wind-powered generator device further includes at least one safety shield, guard, or grill to guard against damage to the rotor blades of the wind turbine that could occur if thrown, inserted, or flying objects (e.g., debris, tree leaves and limbs, baseballs and other sporting equipment, and human fingers or limbs) and animals (e.g., birds, bats and other flying mammals, and large insects) impact the rotor blades. The rotor blades may be enclosed within front and rear grills in some embodiments.

The wind-powered generator device 10 includes a converter device 14 that serves multiple purposes. The converter device steps up voltage (and/or amperage) from the generator of the wind turbine for transmission via power cables electrically connected to the electrical vehicle, electrical device, or battery. In most embodiments, the converter device also converts the alternating current (AC) output of the wind turbine to direct current (DC) output. However, in some embodiments, the converter device converts DC output from the wind turbine to AC output. In some embodiments the converter device is a transformer. In exemplary embodiments, the converter device is an electrical converter. The electrical converter steps up low output voltage of wind turbine’s generator to a higher voltage level and converts variable frequency power output from the wind turbine to fixed frequency electricity for storage in a battery or to power an electrical vehicle or electrical device. Electrical energy produced by the generator of the wind turbine is transmitted to the electrical converter that converts an electrical output of the generator to a required electrical voltage such as, for example, 110/120 volts, 12 volts, voltage acceptable for USB charging (e.g., 5 volts), etc. The electrical converter may be selected, operated, or controlled based on the desired required electrical voltage.

The support member 16 to which the wind turbine 12 is attached supports the wind turbine above a ground or floor surface to allow better access to wind. As mentioned elsewhere herein, in most embodiments, the support member is also retractable along with the wind turbine attached to it. Retraction of the support member and wind turbine reduces drag when a vehicle to which the wind-powered generator device is attached is in motion while allowing for quick deployment of the wind turbine by raising it and the support member when the vehicle is parked and not being driven. The support member may be a support tower, a strut, or a mast. When the wind turbine is in operation, the support member is oriented vertically with the wind turbine connected at a top end of the support member. A bottom end of the support member is connected to a mounting device.

The mounting device 18 attaches the wind-powered generator device 10 to an object or a surface. Examples of the object to which the mounting device of the wind-powered generator device is attachable include an electric vehicle, a hybrid vehicle, another vehicle, a camper, a trailer, a building or other structure, or an electrical device. In some cases, attachment of the mounting device to more than one object may be necessary or desirable. Examples of the surface to which the mounting device of the wind-powered generator device is attachable include a ground surface, a floor surface, a surface of an object (as described above), or a combination of two or more of the foregoing. The mounting device is attached on at least one side or to at least one portion of the bottom end of the support member. The mounting device is attachable to an exterior surface of a vehicle or other object or surface and is detachable from the vehicle or other object or surface for placement or mounting on another vehicle, structure, or surface.

In exemplary embodiments, the mounting device includes rails (e.g., one, two, three, four, or more rails) that are attachable to a roof or other top surface of the vehicle, other object, or surface. The mounting device can include one or more fasteners (e.g., screws, pins, bolts, clips, or any other suitable fasteners) for attaching to the vehicle, other object, or surface. In some embodiments, the mounting device may be a permanently attached part or a removably attached part of the bottom end of the support member. Welding or glue may also be used to attached the mounting device to the vehicle, other object, or surface. For example, the bottom end of the support member may include a plate that is attachable to the vehicle, other object, or surface using fasteners or other modes of attachment.

Other modes of attachment may include embodiments in which a receiving device is attached to the vehicle, other object, or surface using fasteners, glue, or welding so that a void is defined between a bottom surface of the receiving surface and an exterior surface of the vehicle, other object, or surface. A portion or all of the plate of the mounting device attached to the bottom end of the support member is insertable into the void so that, once inserted therein, the plate is secured in a fixed position with the support member in a vertical operating position.

In exemplary embodiments, the wind-powered generator device 10 further includes an elevating device 26 for elevating or raising the wind turbine and support member when the wind turbine is in operation and for retracting or lowering the wind turbine and support member when the wind turbine is not in operation. The elevating device includes a first connection to which a bottom end of the support member is attached and a second connection to which the mounting device is attached. By operating the elevating device, the wind turbine and support member are configurable in the vertical operating position that is raised when the wind turbine is desired to be placed in operation and is configurable in a horizontal retracted position that is lowered when the wind turbine not in operation. The elevating device may be manually adjustable, mechanically operable, or both. For example, in some embodiments, the elevating device is a pivot hinge or joint member disposed between the bottom end of the support member and the mounting device so that the wind turbine or support member may be manually adjusted by lifting or raising them to elevate the wind turbine to its vertical operating position and by pulling or lowering them to retract the wind turbine into the horizontal retracted position when the wind turbine is not in operation.

In other embodiments, the elevating device may be a mechanical or motorized device that is controlled by actuating controls such as a button or switch that, once actuated, automatically raises or lowers the wind turbine and support element.

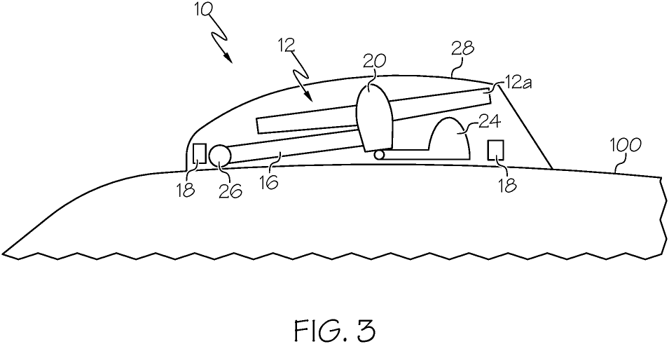

When the wind-powered generator device is attached to a vehicle, e.g., to an automobile, the elevating device is operable to retract the wind turbine and support member into the horizontal retracted position (as shown in FIG. 3) for during driving and during storage of the vehicle in a garage or other structure with low clearance or low ceilings. In most embodiments, the wind-powered generator device is not intended to be used when a vehicle is moving because the power gained from operation of the wind turbine does not outweigh the power used by the vehicle due to additional drag on the vehicle that would occur when the vehicle is moving and the wind turbine is configured in its vertical operating position.

In some embodiments, however, the wind turbine may be put in operation when the vehicle is moving. For such use, a shorter support member may be used to reduce drag as much as possible. In some embodiments, the support member may be omitted so that the wind turbine is connected at or near its bottom surface either directly to the mounting device or directly to the elevating device.

As mentioned elsewhere herein, the wind-powered generator device includes one or more power cables necessary to electrically connect the generator of the wind turbine to the electrical converter and the electrical converter to the vehicle, electrical device, or battery. In most cases, as described herein, a plurality of power cables (and at least two power cables) are necessary to make these electrical connections. The at least one power cable connects the electrical converter to the battery or to the vehicle or electrical device to transmit electricity generated by the wind turbine to the battery for storage or to the vehicle or electrical device to power the same. The wind-powered generator device may also include rapid charging devices that permit faster (e.g., Level 2 and Level 3 charging of EVs) charging. The rapid charging devices allow charging of an EV (or electrical device) to be completed at much faster rates. The rapid charging devices may include a first electrical connection to a power cable of the wind-powered generator device and a second electrical connection to the vehicle, electrical device, or battery to be powered or charged.

The wind-powered generator device 10 may also include a storage cover 28 for enclosing the wind turbine, the electrical converter, the support member, and at least a part of the mounting device. These components may be enclosed and protected from the elements during storage when the wind-powered generator device is not in use. The storage cover is a housing or casing to enclose and protect the components of the wind turbine and other parts of the wind-powered generator device when the wind turbine is not in operation and is configured in the horizontal retracted position. The storage cover can be aerodynamic in shape. The storage cover may be constructed so as to be lightweight, waterproof, corrosion resistant, or a combination of two or more of the foregoing. For example, the storage cover may be constructed from plastic, aluminum, or stainless steel.

The invention also relates to a wind-powered vehicle system for converting kinetic energy of wind into electrical energy to supply power to a vehicle, an electrical device, or a battery. The wind-powered vehicle system includes a vehicle that is an electric vehicle or a hybrid vehicle, which has a battery for storing electricity, and a wind-powered generator device as described elsewhere herein.

The invention also relates to a wind-powered system for converting kinetic energy of wind into electrical energy to supply power to an electrical device. The wind-powered system includes an electrical device as described elsewhere herein and a wind-powered generator device as also described elsewhere herein. The electrical device includes a battery for storing electricity in some embodiments, while in other embodiments, the electrical device does not include a battery but is operable only when power is supplied by the wind-powered generator device. The electrical device is charged using electricity produced by the wind-powered generator device.

The invention also relates to a wind-powered system for converting kinetic energy of wind into electrical energy to charge a battery. The wind-powered system includes a battery as described elsewhere herein and a wind-powered generator device as also described elsewhere herein. The battery is charged using electricity produced by the wind-powered generator device.

The wind-powered generator device, as described elsewhere herein, may be provided as a kit, which includes all of the components (e.g., the mounting device and any additional fasteners, brackets, and other attachment implements) necessary to attach the wind-powered generator device to a vehicle, an object, or a surface. In this manner, the wind-powered generator device is useful for retrofitting new and existing vehicles having hybrid or fully electric systems to supply a power source, including as a supplemental or a backup power source.

The invention also relates to a method for powering an electric vehicle using kinetic energy of wind that is converted into electrical energy. The method includes the step of mounting to a vehicle a wind-powered generator device as described elsewhere herein. Examples of the vehicle are also described elsewhere herein. The method also includes the step of placing the wind turbine and support member of the wind-powered generator device in a vertical operating position that is raised to produce electricity as wind turns a fan blade assembly of the wind turbine. The method also includes the step of transmitting the electricity via at least one power cable to the vehicle to power it or to a battery of the vehicle for storage (i.e., for charging of the vehicle’s battery).

In some embodiments of this method, the method also includes the step of placing the wind turbine and support member in a horizontal retracted position that is lowered when the wind turbine is not in operation.

The invention also relates to a method for powering an electrical device using wind power that is converted into electrical energy. The method includes the step of mounting to an object or to a surface a wind-powered generator device as described elsewhere herein. Examples of the object and the surface are also described elsewhere herein. The method also includes the step of placing the wind turbine and support member of the wind-powered generator device in a vertical operating position that is raised to produce electricity as wind turns a fan blade assembly of the wind turbine. The method also includes the step of transmitting the electricity via at least one power cable to the electrical device to power it or to charge a battery of the electrical device.

In some embodiments of this method, the method also includes the step of placing the wind turbine and support member in a horizontal retracted position that is lowered when the wind turbine is not in operation.

The invention also relates to a method for charging a battery using wind power that is converted into electrical energy. The method includes the step of mounting to an object or to a surface a wind-powered generator device as described elsewhere herein. Examples of the battery, the object, and the surface are also described elsewhere herein. The method also includes the step of placing the wind turbine and support member of the wind-powered generator device in a vertical operating position that is raised to produce electricity as wind turns a fan blade assembly of the wind turbine. The method also includes the step of transmitting the electricity via at least one power cable to the battery to charge the battery.

In some embodiments of this method, the method also includes the step of placing the wind turbine and support member in a horizontal retracted position that is lowered when the wind turbine is not in operation.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A wind-powered generator device, wherein the wind-powered generator device comprises:
a wind turbine, wherein the wind turbine is retractable when not in operation;
an electrical converter to convert variable frequency power output from the wind turbine to fixed frequency electricity for storage in a battery or to power a device;
a support member to which the wind turbine is attached;
a mounting device to which a bottom end of the support member is attached, wherein the mounting device attaches the wind-powered generator device to an object or a surface; and
an elevating device comprising a first connection to which a bottom end of the support member is attached and a second connection to which the mounting device is attached, wherein the wind turbine and support member are configurable in a vertical operating position that is raised and in a horizontal retracted position that is lowered when the wind turbine not in operation.

2. The wind-powered generator device of claim 1, wherein the battery comprises a battery of a vehicle, a home battery, or a battery of another electrical device; and wherein the device comprises an electric vehicle, a hybrid vehicle, or another electrical device.

3. The wind-powered generator device of claim 1, wherein the object comprises an electric vehicle, a hybrid vehicle, another vehicle, a trailer, a building or other structure, or an electrical device; and wherein the surface comprises a ground surface or a floor surface.

4. The wind-powered generator device of claim 1, wherein the mounting device is attachable to an exterior surface of a vehicle and is detachable for placement or mounting on another vehicle, structure, or ground surface.

5. The wind-powered generator device of claim 4, wherein the mounting device comprises rails that are attachable to a roof or other top surface of the vehicle, structure, or ground.

6. The wind-powered generator device of claim 1, further comprising a yaw mechanism that is rotatable for orienting the wind turbine in a direction of wind.

7. The wind-powered generator device of claim 6, wherein the yaw mechanism is attached at a first end to the wind turbine and at a second end to a top end of the support member.

8. The wind-powered generator device of claim 1, wherein the wind turbine comprises a rudder to orient a fan side of the wind turbine in a direction from which wind is blowing.

9. The wind-powered generator device of claim 1, wherein the wind turbine comprises a nacelle enclosing a gear box and a generator of the wind turbine.

10. The wind-powered generator device of claim 1, further comprising at least one power cable for connecting the electrical converter to the battery or to the device to transmit electricity generated by the wind turbine to the battery for storage or to the device to power the device.

11. The wind-powered generator device of claim 1, further comprising a storage cover for enclosing the wind turbine, the electrical converter, the support member, and at least a part of the mounting device.

12. A wind-powered vehicle system, wherein the wind-powered vehicle system comprises:
a vehicle comprising an electric vehicle or a hybrid vehicle, wherein the vehicle comprises a battery for storing electricity;
a wind-powered generator device comprising:
a wind turbine, wherein the wind turbine is retractable when not in operation;
an electrical converter to convert variable frequency power output from the wind turbine to fixed frequency electricity for storage in the battery of the vehicle;
a support member to which the wind turbine is attached;
a mounting device to which a bottom end of the support member is attached; and
an elevating device comprising a first connection to which a bottom end of the support member is attached and a second connection to which the mounting device is attached, wherein the wind turbine and support member are configurable in a vertical operating position that is raised and in a horizontal retracted position that is lowered when the wind turbine not in operation.

13. The wind-powered vehicle system of claim 12, wherein the mounting device is attachable to an exterior surface of the vehicle and is detachable for placement or mounting on another vehicle, structure, or ground surface.

14. The wind-powered vehicle system of claim 13, wherein the mounting device comprises rails that are attachable to a roof or other top surface of the vehicle.

15. The wind-powered vehicle system of claim 12, further comprising a yaw mechanism that is rotatable for orienting the wind turbine in a direction of wind.

16. The wind-powered vehicle system of claim 15, wherein the yaw mechanism is attached at a first end to the wind turbine and at a second end to a top end of the support member.

17. The wind-powered vehicle system of claim 12, wherein the wind turbine comprises a rudder to orient a fan side of the wind turbine in a direction from which wind is blowing.

18. The wind-powered vehicle system of claim 12, wherein the wind turbine comprises a nacelle enclosing a gear box and a generator of the wind turbine.

19. The wind-powered vehicle system of claim 12, further comprising at least one power cable for connecting the electrical converter to the battery of the vehicle to transmit electricity generated by the wind turbine to the battery for storage.

20. The wind-powered vehicle system of claim 12, further comprising a storage cover for enclosing the wind turbine, the electrical converter, the support member, and at least a part of the mounting device.

21. A method for powering a vehicle using wind, the method comprising the steps of:
(a) mounting to a vehicle a wind-powered generator device comprising:
a wind turbine, wherein the wind turbine is retractable when not in operation;
an electrical converter to convert variable frequency power output from the wind turbine to fixed frequency electricity for storage in a battery of a vehicle, wherein the vehicle comprises an electric vehicle or a hybrid vehicle;
a support member to which the wind turbine is attached;
a mounting device to which a bottom end of the support member is attached; and
an elevating device comprising a first connection to which a bottom end of the support member is attached and a second connection to which the mounting device is attached;
(b) placing the wind turbine and support member in a vertical operating position that is raised to produce electricity as wind turns a fan blade assembly of the wind turbine; and
(c) transmitting the electricity via at least one power cable to the battery of the vehicle for storage.

22. The method of claim 21, further comprising the step of:
(d) placing the wind turbine and support member in a horizontal retracted position that is lowered when the wind turbine is not in operation.
